(19) United States
(12) Patent Application Publication
(10) Pub. No.: US 2026/0032637 A1
(43) Pub. Date: Jan. 29, 2026

(54) METHOD FOR ENHANCED POSITION ESTIMATION

(71) Applicant: Robert Bosch GmbH, Stuttgart (DE)

(72) Inventors: Maximilian Stark, Hamburg (DE); Guillaume Jornod, Bern (CH); Viet Hoang Le, Hamburg (DE)

(21) Appl. No.: 19/266,442

(22) Filed: Jul. 11, 2025

(30) Foreign Application Priority Data
Jul. 24, 2024 (DE) 10 2024 206 951.5

(51) Int. Cl. H04W 64/00; H04B 1/7163; H04L 41/16

(52) U.S. Cl. CPC H04W 64/006; H04B 1/7163; H04L 41/16

(57) ABSTRACT

A method for enhanced position estimation using a distributed antenna system. The method includes: receiving input data based on at least one measurement resulting from a ranging procedure using a distributed antenna system, wherein the ranging procedure specifies measures for determining a distance dx depending on a signal propagation regarding the ranging procedure; providing at least one neural network model, wherein the at least one neural network model specifies a spatial pattern recognition and/or a temporal sequence to process the input data; combining the input data using the at least one neural network model to provide an enhanced position estimate; and providing a position result based on the combining.

### CROSS REFERENCE

The present application claims the benefit under 35 U.S.C. § 119 of Germany Patent Application No. DE 10 2024 206 951.5 filed on Jul. 24, 2024, which is expressly incorporated herein by reference in its entirety.

### FIELD

The present invention relates to a method for enhanced position estimation using a distributed antenna system. Furthermore, the present invention relates to a computer program, a data processing apparatus, and a storage medium for this purpose.

### BACKGROUND INFORMATION

Current real-time localization systems, such as GPS and lidar, are widely used for vehicle and pedestrian tracking. However, these systems can face significant challenges in urban environments due to signal degradation, multipath effects, and obstructions from buildings and other structures. These limitations reduce the accuracy and reliability of position estimates, which can be critical for applications like autonomous driving, V2X (Vehicle-to-Everything) communication, and the protection of vulnerable road users (VRUs). Communication technologies such as for example Ultra-Wideband (UWB) technology emerges as a promising solution due to its high precision and low interference characteristics. However, UWB's performance is significantly affected by Non-Line-of-Sight (NLOS) conditions, leading to increased errors and data loss. Traditional approaches to mitigate these issues often fall short, necessitating more advanced solutions.

### SUMMARY

According to aspects of the present invention, a method, a training method, a computer program, a data processing apparatus, and a computer readable storage medium are provided. Features and details of the present invention are disclosed herein. Features and details described in the context of the method according to the present invention also correspond to the inventive training method, the inventive computer program, the inventive data processing apparatus as well as the inventive computer-readable storage medium, and vice versa in each case.

According to an aspect of the present invention a method for enhanced position estimation using a distributed antenna system is provided. According to an example embodiment of the present invention, the method comprises the following steps:
Receiving input data based on at least one measurement resulting from a ranging procedure using a distributed antenna system, wherein the ranging procedure specifies measures for determining a distance dx depending on a signal propagation regarding the ranging procedure,
Providing at least one neural network model, wherein the at least one neural network model specifies a spatial pattern recognition and/or a temporal sequence to process the input data,
Combining the input data using the at least one neural network model to provide an enhanced position estimate,
Providing a position result based on the combining.

A distributed antenna system can be understood as an antenna system comprising at least two, preferably multiple antennas, which are spatially distributed. Preferably, the at least two antennas of the antenna system are arranged on a mobile or stationary platform, e.g., a vehicle, a user equipment, an infrastructure element like a road side unit etc. A distance between at least two antennas of the distributed antenna system is greater, preferably at least twice, more preferred at least ten times greater, than a size of the antenna.

The position result represents the enhanced position estimate.

The combined use of various neural network models, along with the strategic deployment of a distributed antenna system, in particular around a vehicle, using for example a keyless entry system, has the advantage that the present invention enables to significantly improve the accuracy and reliability of a localization system. Further, this allows to ensure a robust performance even in a complex urban environment. Furthermore, the method of the present invention allows to significantly improve localization for applications in autonomous driving or smart transportation systems. The usage of a distributed antenna system allows to provide multiple reference points for a signal reception during a ranging procedure. This can advantageously mitigate the effects of non-line-of-sight (NLOS) conditions and significantly improves the overall positioning accuracy.

According to an example embodiment of the present invention, it is further possible that the at least one neural network model comprises a hybrid neural network model using a convolutional neural network and a multilayer perceptron to process the input data, wherein during the combining the method comprises the further following steps:
Extracting spatial features from the received input data based on the convolutional neural network model,
Refining the spatial features to determine the position estimate depending on the multilayer perceptron.

This hybrid model has the advantage that it leverages spatial pattern recognition capabilities of a convolutional neural network model (CNN) and the dense layer processing of a multilayer perceptron (MLP), allowing a balance between complexity and performance, which can advantageously be suitable when for example using real-time applications on embedded systems with limited computational resources.

According to an example embodiment of the present invention, it is further possible that the at least one neural network model comprises a recurrent neural network model specifying the temporal sequence, wherein during the combining the method comprises the further following step:
Processing sequential measurements regarding the ranging procedure based on the recurrent neural network model.

This has the advantage that using this model can be effective in dynamic environments where conditions may change rapidly, such as for example for moving vehicles and/or VRUs in urban settings. A long short-term memory (LSTM) unit of the recurrent neural network advantageously allows to mitigate the impact of non-line-of-sight (NLOS) conditions by leveraging temporal patterns.

According to an example embodiment of the present invention, it is possible that the at least one neural network model comprises a fusion neural network model using a convolutional and a recurrent neural network model, wherein the method comprises the further following steps:
Performing at least one preprocessing step to process the received input data,
Assessing accuracy and/or robustness of the processed input data using metrics such as Root Mean Square Error and/or Mean Absolute Error,
Fusing the processed input data to improve a reliability of the position estimate.

According to an example embodiment of the present invention, it is possible that the localization system uses a convolutional neural network for spatial pattern recognition and a recurrent neural network for temporal dependency learning. This combined approach allows the system to utilize multiple data sources for more reliable and accurate position estimation. The data fusion approach using different neural network models has the advantage to significantly enhance the robustness of the localization system by integrating diverse data streams, improving its ability to handle complex environments and/or NLOS conditions.

It is further possible that the input data comprises a channel impulse response, a Received Signal Strength Indicator and/or ranging data based on the ranging procedure.

This combination of input data provided by a distributed antenna system allows to obtain a significantly improved localization and/or more accurate and reliable position estimate.

According to an example embodiment of the present invention, it is also possible that the method comprises at least one of the further following steps:
Measuring a time of flight, a received signal strength indicator, and/or a channel impulse response data based on the ranging procedure using the distributed antenna system,
Calculating at least one range from a time of flight based on the ranging procedure and based on the distributed antenna system,
Determining the position estimate based on the provided neural network model.

It is possible that the method comprises further steps for an enhanced position estimation using a communication technology like for example an ultra-wideband technology. The at least one neural network model advantageously processes input data from various measurements, including time of flight, received signal strength indicator, and channel impulse response data to determine a distance or a range.

It is possible that during the combining the method comprises at least one of the following further steps:
Performing a weighting average method of the combined input data,
Performing a weighting average method of the combined input data, wherein weights of the weighting average method are dependent on external conditions, in particular urban and/or rural scenarios.

The weighting average method advantageously enables to aggregate the combined input data, allowing for a more accurate and more reliable position estimate. Further, this allows to consider external conditions, such as urban or rural scenarios, which can significantly impact positioning accuracy. By incorporating these environmental factors into the weighting process, the method can adapt to varying conditions, ultimately enhancing the overall precision of the localization result.

According to an example embodiment of the present invention, it is further possible that the input data is based on ultra-wideband measurements based on a ranging procedure, preferably between a vulnerable road user and a vehicle, wherein the vehicle comprises an ultra-wideband antenna system comprising at least two antennas. In other words, the vehicle comprises a distributed antenna system configured as an ultra-wideband antenna system with at least two spatially distributed antennas. It is possible that the input data originates from ultra-wideband measurements conducted between a vulnerable road user, such as a cyclist or pedestrian, and a vehicle equipped with an ultra-wideband antenna system featuring at least two antennas. This system enables precise distance determination between the user and the vehicle based on signal propagation characteristics. This allows for accurate positioning in urban environments by leveraging existing UWB installations in vehicles, reducing implementation costs and complexity.

Another aspect of the present invention is a training method for a neural network model used in the inventive method. According to an example embodiment of the present invention, the training method comprises the following steps:
Providing a dataset comprising multiple line of sight and/or non-line-of-sight scenarios when performing a positioning procedure,
Initiating a ranging procedure between at least two objects, wherein at least one of the at least two objects comprises a distributed antenna system,
Receiving input data based on measurements regarding the ranging procedure, wherein the input data comprise ranging data and/or a channel impulse response and/or a Received Signal strength Indicator,
Learning temporal and/or spatial correlations from input data based on the measurements regarding the ranging procedure,
Adjusting weights of the neural network model through backpropagation and/or gradient descent algorithms.

Thus, the training method according to the present invention brings the same advantages as have been described in detail above with reference to the method of the present invention.

According to an example embodiment of the present invention, it is possible that the neural network model can be trained on a dataset that includes both line-of-sight and non-line-of-sight scenarios. This allows the model to learn patterns in transmitted signals like for example UWB signals under various conditions, enhancing its accuracy. The training process involves receiving input data from ranging procedures between objects, potentially including distributed antenna systems. The model learns temporal and spatial correlations from this data, adjusting its weights through algorithms like backpropagation and gradient descent. This can lead to improved performance in dynamic environments and challenging indoor settings.

In another aspect of the present invention, a computer program may be provided, in particular a computer program product, comprising instructions which, when the computer program is executed by a computer, cause the computer to carry out the method(s) according to the present invention. Thus, the computer program according to the present invention can have the same advantages as have been described in detail with reference to a method according to the present invention.

In another aspect of the present invention, an apparatus for data processing may be provided, which is configured to execute the method according to the present invention. As the apparatus, for example, a computer can be provided which executes the computer program according to the present invention. The computer may include at least one processor that can be used to execute the computer program. Also, a non-volatile data memory may be provided in which the computer program may be stored and from which the computer program may be read by the processor for being carried out.

According to another aspect of the present invention, a computer-readable storage medium may be provided which comprises the computer program according to the present invention and/or instructions which, when executed by a computer, cause the computer to carry out the steps of the method according to the present invention. The storage medium may be formed as a data storage device such as a hard disk and/or a non-volatile memory and/or a memory card and/or a solid state drive. The storage medium may, for example, be integrated into the computer.

Furthermore, the method according to the present invention may be implemented as a computer-implemented method. Alternatively, or additionally, at least one of the disclosed method steps of the present invention may be computer-implemented and/or automated.

Further advantages, features and details of the present invention will be apparent from the following description, in which embodiments of the present invention are described in detail with reference to the figures. In this context, the features mentioned in the disclosure herein may each be essential to the present invention individually or in any combination.

### BRIEF DESCRIPTION OF THE DRAWINGS

FIG. 1 shows a method, computer program, a storage medium, and apparatus according to example embodiments of the present invention.

FIG. 2 shows a schematic diagram according to example embodiments of the present invention.

FIG. 3 shows a schematic overview of an exemplary neural network model according to example embodiments of the present invention.

FIG. 4 shows a schematic flow diagram of a training method according to embodiments of the present invention.

### DETAILED DESCRIPTION OF EXAMPLE EMBODIMENTS

The present invention is an integration of advanced neural network architectures with a communication technology, preferably with an ultra-wideband technology, and a distributed antenna system to enhance real-time localization accuracy and robustness.

The utilization of a distributed antenna system may enhance the UWB performance by providing multiple points of reference for signal reception. This distributed approach helps in reducing the impact of signal obstructions and improving overall positioning accuracy. By integrating machine learning techniques with a communication technology like for example ultra-wideband (UWB) or WiFi and distributed antennas, the present invention aims to significantly enhance localization reliability and accuracy in complex urban environments.

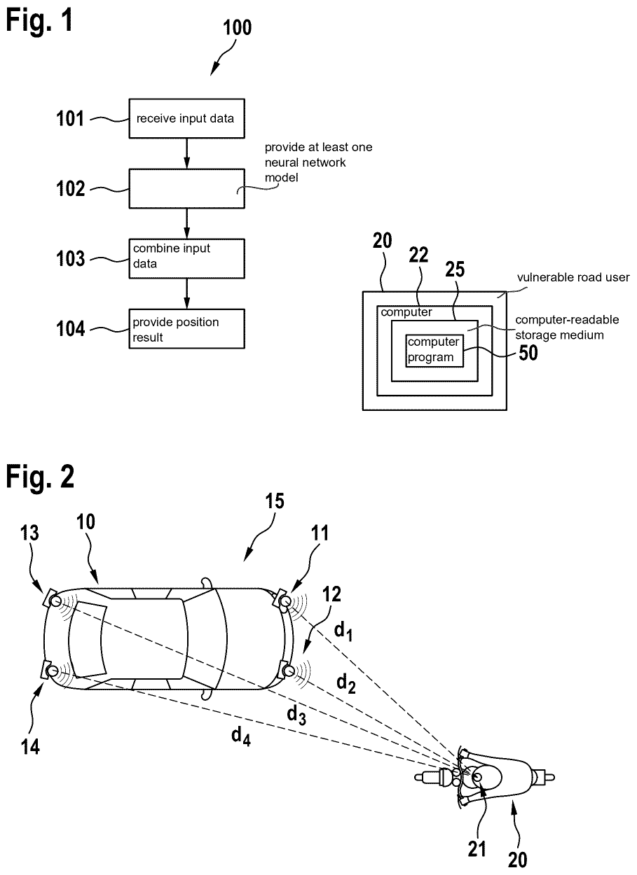

FIG. 1 depicts a method 100, a computer program 50, a computer-readable storage medium 25 and a data processing apparatus 20 according to embodiments of the present invention.

FIG. 1 particularly shows an embodiment of a method 100 for enhanced position estimation using a distributed antenna system 15, comprising the following steps:

In a step 101 input data is received based on at least one measurement resulting from a ranging procedure using a distributed antenna system 15. The ranging procedure specifies measures for determining a distance dₓ depending on a signal propagation regarding the ranging procedure. At a step 102 at least one neural network model is provided. The at least one neural network model specifies a spatial pattern recognition and/or a temporal sequence to process the input data. In a step 103 the input data is combined using the at least one neural network model to provide an enhanced position estimate. At a step 104 then a position result is provided based on the combining in step 103.

FIG. 2 depicts a schematic diagram according to embodiments of the invention. Particularly, FIG. 2 shows a vehicle 10 and a vulnerable road user 20 (VRU). The vulnerable road user 20 as depicted in FIG. 2 can be a motorcycle or a bicycle and may comprises at least one antenna 21 or a UWB tag 21. The VRU 20 may optionally be a pedestrian. Further, the VRU 20 can comprise a computer 22. The vehicle 10 comprises a distributed antenna system 15 comprising four antennas 11, 12, 13, 14. It is possible that the four antennas 11, 12, 13, 14 are part of a keyless entry system 15 of the vehicle 10. The distributed antenna system 15 can be based on a communication technology such as for example Wi-Fi or W-Lan, Bluetooth or ultra-wideband (UWB) technology.

The vulnerable road user 20 may trigger a ranging procedure with the vehicle 10, wherein the signals exchanged between the VRU 20 and the vehicle 10 are UWB signals used for the ranging procedure. The one or more VRU tags 21 polls each UWB tag 11, 12, 13, 14 of the vehicle 10, which can be for example antennas 11, 12, 13, 14 from
the keyless entry system 15 of the vehicle 10. Each antenna 11, 12, 13, 14 will respond to the VRU tag 21 by transmitting a signal. For each of its one or more tags 21, the VRU 20 can calculate a range d₁, d₂, d₃, d₃ from the time of flight, but can also measure a Reflected Signal Strength Indicator (RSSI and/or a channel impulse response. This is performed for each calculated range d₁, d₂, d₃, d₄. The VRU 20 then combines these measurements to provide an enhanced position estimation using machine learning techniques.

The usage of machine learning techniques such as using at least one neural network model, along with the deployment of distributed antennas around an object like a vehicle 10 enables the invention to significantly improve the accuracy and reliability of the localization system. This approach ensures robust performance even in challenging urban environments, making it ideal for applications in autonomous driving and smart transportation systems. In other words, the usage of range data, RSS, and CIR from a distributed antenna system in a combination of neural network and fusion techniques allows to obtain an improved localization.

In another embodiment the invention may repurpose for example existing UWB installations in vehicles, typically used for keyless entry systems as illustrated in FIG. 2. These installations, distributed around the vehicle 10, provide an ideal framework for enhanced localization, i.e., providing an enhanced position estimate. By leveraging the existing antennas 11, 12, 13, 14 as shown in FIG. 2, the invention reduces implementation costs and complexity. The distributed antenna system 15 provides multiple reference points 11, 12, 13, 14 for signal reception, mitigating the effects of NLOS conditions and improving overall positioning accuracy.

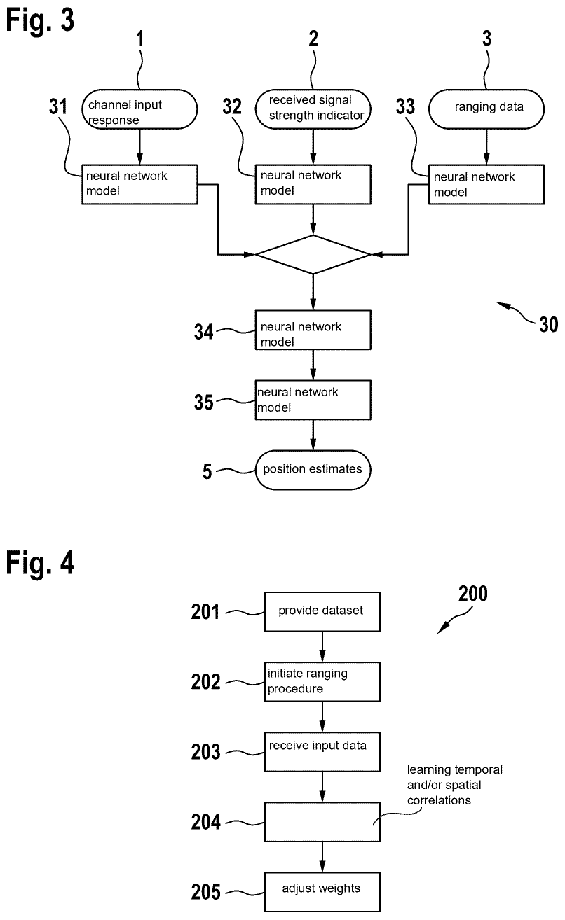

FIG. 3 illustrates a schematic overview of an exemplary neural network model 30 according to embodiments of the invention. In FIG. 3 three different inputs 1,2, 3 for input data based on measurements regarding a ranging procedure are shown.

The neural network model 30 may comprise one or more neural network models 31, 32, 33, 34, 35 or network model units to process the input data 1, 2, 3.

In one embodiment the neural network model 30 comprise a hybrid neural network model 30. The hybrid neural network combines Convolutional Neural Networks 31, 32, 33 (CNN) with Multilayer Perceptrons 34, 35 (MLP) to process the input data 1, 2, 3 based on measurements during a ranging procedure for example based on ultra-wideband technology. Each CNN component 31, 32, 33 is responsible for processing a Channel Impulse Response 1 (CIR), a Received Signal Strength Indicator (RSSI) 2 and ranging data 3. Spatial features are extracted from these inputs 1, 2, 3. The MLP component(s) 34, 35 further refines these features to estimate an accurate position.

The model 30 can be trained using a comprehensive dataset that includes both Line-of-Sight (LOS) and Non-Line-of-Sight (NLOS) scenarios. During training, the network learns to minimize the error in position estimates by adjusting its weights through backpropagation and gradient descent algorithms. In case the LOS is missing, the system 30 can detect it and for example may avoid confusing the strongest NLOS as LOS.

In another embodiment the at least one neural network model 30 is a Recurrent Neural Network (RNN) as depicted in FIG. 3. The Recurrent Neural Network (RNN) 30 utilizes gated recurrent units and/or Long Short-Term Memory (LSTM) units 31, 32, 33, 34, 35, to process sequential measurements regarding the ranging procedure. The RNN architecture 30 captures temporal dependencies in the input data 1, 2, 3, which are crucial for improving localization accuracy over time.

The RNN 30 is trained on a dataset reflecting real-world dynamic scenarios, including both LOS and NLOS conditions. The training process focuses on learning the temporal correlations in the data, allowing the model to predict positions with higher accuracy despite changes in environmental conditions.

In another embodiment not depicted in FIG. 3 the at least one neural network model 30 is based on a data fusion model. The model 30 employs a mixed neural network architecture to process and fuse measurements, in particular UWB measurements 3, with CIR land RSSI data 2. The model 30 or system 30 uses CNNs for spatial pattern recognition and RNNs for temporal dependency learning, providing a comprehensive approach to data fusion. The data fusion approach comprises several preprocessing steps, like for example normalization, handling missing values, and feature extraction, to ensure that the data 1, 2, 3 is suitable for the neural network model and also for the training. The fusion process integrates diverse data streams 1, 2, 3, improving the reliability of position estimates 5. The combined neural network models are evaluated using metrics such as Root Mean Square Error (RMSE) and Mean Absolute Error (MAE) to assess accuracy and robustness. The system 30 can provide significant improvements in localization performance, particularly under NLOS conditions.

In another embodiment, a further method may be used, which means that the data or measurements 1, 2, 3 are combined, for instance with a weighting average method. Optionally, the weights of the combining are dependent of some external conditions such as urban and rural scenarios.

FIG. 4 shows a schematic flow diagram of a training method 200 according to embodiments of the invention. The training method 200 comprises the following steps:

In a step 201 a dataset is provided comprising multiple line of sight and/or non-line-of-sight scenarios when performing a ranging procedure. At a step 202 a ranging procedure between at least two objects 10, 20 is initiated, wherein at least one of the at least two objects 10, 20 comprises a distributed antenna system 15. Then in a step 203 input data 1, 2, 3 is received based on measurements regarding the ranging procedure. The input data 1, 2, 3 comprise ranging data and/or a channel impulse response and/or a Received Signal strength Indicator. In step 204 temporal and/or spatial correlations is learned from input data 1, 2, 3 based on the measurements regarding the ranging procedure. In a step 205 weights are adjusted through backpropagation and/or gradient descent algorithms.

Based on a performance comparison between embodiments of the inventive method 100 and for example an Adaptive Subgradient Descent (ASGD) method exemplary results of using the inventive method 100 demonstrate a lower absolute position error, indicating higher accuracy and reliability. Further, it can be demonstrated that a larger proportion of position estimates based on the inventive method can achieve lower error margins compared to the ASGD method, which has a more gradual increase and higher error values.

The above explanation of the embodiments describes the present invention in the context of examples. Of course, individual features of the embodiments can be freely combined with each other, provided that this is technically reasonable, without leaving the scope of the present invention.

What is claimed is:

1. A method for enhanced position estimation using a distributed antenna system, the method comprising the following steps:
receiving input data based on at least one measurement resulting from a ranging procedure using a distributed antenna system, wherein the ranging procedure specifies measures for determining a distance depending on a signal propagation regarding the ranging procedure;
providing at least one neural network model, wherein the at least one neural network model specifies a spatial pattern recognition and/or a temporal sequence to process the input data;
combining the input data using the at least one neural network model to provide an enhanced position estimate; and
providing a position estimate based on the combining.

2. The method of claim 1, wherein the at least one neural network model includes a hybrid neural network model using a convolutional neural network and a multilayer perceptron to process the input data, and wherein, during the combining, the following further steps are performed:
extracting spatial features from the received input data based on the convolutional neural network model; and
refining the spatial features to determine the position estimate depending on the multilayer perceptron.

3. The method of claim 1, wherein the at least one neural network model includes a recurrent neural network model specifying the temporal sequence, and wherein, during the combining, the following further step is performed:
processing sequential measurements regarding the ranging procedure based on the recurrent neural network model.

4. The method of claim 1, wherein the at least one neural network model includes a fusion neural network model using a convolutional and a recurrent neural network model, and wherein the method further comprises the following steps:
performing at least one preprocessing step to process the received input data;
assessing accuracy and/or robustness of the processed input data using metrics such as Root Mean Square Error and/or Mean Absolute Error; and
fusing the processed input data to improve a reliability of the position estimate.

5. The method of claim 1, wherein the input data includes a channel impulse response, and/or a Received Signal Strength Indicator and/or ranging data based on the ranging procedure.

6. The method of claim 1, further comprising at least one of the following steps:
measuring a time of flight, and/or a received signal strength indicator, and/or a channel impulse response data based on the ranging procedure using the distributed antenna system;
calculating at least one range from a time of flight based on the ranging procedure and based on the distributed antenna system;
determining the position estimate based on the provided neural network model.

7. The method of claim 1, wherein, during the combining, at least one of the following further steps is performed:
performing a weighting average method of the combined input data;
performing a weighting average method of the combined input data, wherein weights of the weighting average method are dependent on external conditions including urban and/or rural scenarios.

8. The method of claim 1, wherein the input data is based on ultra-wideband measurements based on a ranging procedure, between a vulnerable road user and a vehicle, wherein the vehicle includes an ultra-wideband antenna system includes at least two antennas.

9. A training method for a neural network model, comprising the following steps:
providing a dataset including multiple line of sight and/or non-line-of-sight scenarios when performing a ranging procedure;
initiating a ranging procedure between at least two objects, wherein at least one of the at least two objects includes a distributed antenna system;
receiving input data based on measurements regarding the ranging procedure, wherein the input data include ranging data and/or a channel impulse response and/or a Received Signal strength Indicator;
learning temporal and/or spatial correlations from the input data based on the measurements regarding the ranging procedure; and
adjusting weights of the neural network model through backpropagation and/or gradient descent algorithms.

10. An apparatus, comprising:
a data processing apparatus for enhanced position estimation using a distributed antenna system, the data processing apparatus configured to:
receive input data based on at least one measurement resulting from a ranging procedure using a distributed antenna system, wherein the ranging procedure specifies measures for determining a distance depending on a signal propagation regarding the ranging procedure,
provide at least one neural network model, wherein the at least one neural network model specifies a spatial pattern recognition and/or a temporal sequence to process the input data;
combine the input data using the at least one neural network model to provide an enhanced position estimate, and
provide a position estimate based on the combining.

11. A non-transitory computer-readable storage medium on which are stored instructions for enhanced position estimation using a distributed antenna system, the instructions, when executed by a computer, causing the computer to perform the following steps:
receiving input data based on at least one measurement resulting from a ranging procedure using a distributed antenna system, wherein the ranging procedure specifies measures for determining a distance depending on a signal propagation regarding the ranging procedure;
providing at least one neural network model, wherein the at least one neural network model specifies a spatial pattern recognition and/or a temporal sequence to process the input data;
combining the input data using the at least one neural network model to provide an enhanced position estimate; and
providing a position estimate based on the combining.
